(19) United States
(12) Patent Application Publication
(10) Pub. No.: US 2026/0168523 A1
(43) Pub. Date: Jun. 18, 2026

(54) DEVICE FOR CONTROLLING A HYDRAULIC PUMP OR A HYDRAULIC MOTOR

(71) Applicant: Andreas Lupold Hydrotechnik GmbH, Voehringen (DE)

(72) Inventors: Dieter Lohmiller, Voehringen (DE); Marvin Schell, Schramberg (DE); Andreas Ploeckinger, Gunskirchen (DE); Paul Foschum, Gierkeweg (AT); Bernd Winkler, St. Florian (AT); Thomas Zehetbauer, Feldkirchen an der Donau (AT)

(73) Assignee: Andreas Lupold Hydrotechnik GmbH, Voehringen (DE)

(21) Appl. No.: 17/922,609

(22) PCT Filed: Mar. 22, 2022
(86) PCT No.: PCT/EP2022/057550

§ 371 Date: Feb. 10, 2026

(30) Foreign Application Priority Data
Mar. 30, 2021 (DE) 102021108081.9

(51) Int. Cl. F15B 15/18; F01B 25/00; F04B 49/00; F15B 1/26

(52) U.S. Cl. CPC F15B 15/18; F01B 25/00; F04B 49/002; F15B 1/26

(57) ABSTRACT

A device for controlling a hydraulic pump includes a hydraulic fluid reservoir, a hydraulic pump having one inlet and one outlet, and an adjustment unit interacting with the hydraulic pump to be able to change the delivery volume. The adjustment unit is arranged in a high-pressure secondary line connected to the high-pressure line and a high-pressure seat valve is arranged in the high-pressure secondary line and interacts with the adjustment unit. A sensor with which an actual value of at least one characteristic variable that can be influenced by the delivery volume of the hydraulic pump can be detected. An actuator is specified with which a target value of the characteristic variable. A control device which interacts with the sensor and the actuator such that the high-pressure seat valve can be activated, taking into account the actual value detected by the sensor and the target value specified by the actuator.

The present invention relates to a device for controlling a hydraulic pump or a hydraulic motor.

Hydraulic pumps are used in many technical applications to transfer a hydraulic fluid, especially hydraulic oil, from a hydraulic fluid reservoir to a consumer. The consumer can be, for example, a hydraulic cylinder in which, as a result of the pumping of the hydraulic fluid and a resistance offered by the hydraulic system in question and/or a consumer located therein, a pressure builds up which can be converted into a movement or a force. One such component may be, for example, the arm of an excavator. The excavator operator operates the corresponding operating lever, thereby setting a certain target value, for example the volume flow in the hydraulic cylinder. The operating lever therefore acts as an actuator with which the delivery volume of the hydraulic pump is changed.

Known prior art controllers for controlling a hydraulic pump often change the delivery volume by means of an actuating cylinder and appropriately constructed combinations of apertures, springs, throttles and valves, which in turn are passively pre-controlled via pressure feedback from the relevant hydraulic system. Such controllers are known, for example, from DE 24 13 295A1 . In the case of axial piston pumps, changing the delivery volume is also referred to as changing the pivot angle.

Due to the fact that controllers known from the prior art have a specific combination of apertures, springs, throttles and valves, these controllers represent a specific control task with specific control characteristics which can only be changed to a limited extent during operation of the consumer. If the control characteristic needs to be changed, for example a spring or spring assembly must be manually further pre-loaded or replaced by a spring having a different spring characteristic. The same applies to the other hydraulic components of the relevant controller or hydraulic system.

Controllers having an electrical proportional control axis are also known from the prior art and are in some respects somewhat more flexible than the controllers described above; however, this flexibility of the controllers mentioned by the prior art leaves much to be desired. Furthermore, the valves used are in many cases designed as spool or piston valves, which inherently exhibit a certain degree of leakage. This leakage leads to a loss of pressure within the hydraulic system in question and a resulting reduction in the efficiency of the operation of the hydraulic system.

For further relevant prior art, reference is made to DE 36 44 736A1, EP 3 308 236 A1, DE 10 2014 207 958A1, DE 10 2011 120 767A1, DE 20 2009 013 507U1, DE 10 2018 003 728 A1 and DE 10 2012 006 219A1 .

The object of one embodiment or configuration of the present invention is to propose a device for controlling a hydraulic pump or a hydraulic motor and with which it is possible to flexibly solve different control tasks with simple and identically constructed components without significant modifications to the hydraulic components. Furthermore, leakage in the device should be largely reduced, thereby increasing the dynamics and efficiency of the control system.

This object is attained with the features specified in claims 1, 7, 10 and 11. Advantageous embodiments are the subject of the dependent claims.

One embodiment of the invention relates to a device for controlling a hydraulic pump, comprising
a hydraulic fluid reservoir,
a hydraulic pump having one inlet and one outlet, wherein
   the inlet is connected to the hydraulic fluid reservoir by means of a first low-pressure line,
   the outlet is connected to a high-pressure line to which a consumer can be connected,
an adjustment unit interacting with the hydraulic pump and with which the delivery volume of the hydraulic pump can be changed, the adjustment unit being arranged in a high-pressure secondary line connected to the high-pressure line,
a high-pressure seat valve arranged in the high-pressure secondary line and interacting with the adjustment unit,
a sensor with which an actual value of at least one characteristic variable that can be influenced by the delivery volume of the hydraulic pump can be detected,
an actuator with which a target value is specified, and
a control device which interacts with the sensor and the actuator such that the high-pressure seat valve can be activated taking into account the actual value detected by the sensor and the target value specified by the actuator.

The control device can store algorithms that can be used to represent different control tasks and control characteristics. The control device can be designed, for example, to simulate classic controllers, such as PI controllers or PID controllers with and without fixed-value control. To implement certain control characteristics, the control device must simply be set up accordingly. Depending on the application, the desired control characteristic can be selected appropriately during operation. No changes to the hydraulic components are necessary. As a result, the present device for controlling the hydraulic pump exhibits a maximum degree of flexibility.

As proposed, the delivery volume of the hydraulic pump is changed by a corresponding activation of the high-pressure seat valve and consequently by hydraulic means. The speed of the drive motor of the hydraulic pump is not deliberately changed; however, the drive speed can vary due to the load, which does not adversely affect the functionality of the hydraulic system. This offers the advantage that relatively simple drive motors that can be operated without speed control can be used. For example, internal combustion engines that can be operated constantly within their optimal speed range, and consequently economically, can be used. Complex drive motors, such as servo motors whose speed can be controlled, are not necessary. Depending on the application requirements, a variable-speed motor can also be used to add a further controlled variable to take advantage of the properties of the control system.

The hydraulic pump can have any number of pistons. The proposed device acts on all pistons equally. Single pistons are not controlled individually, so that the proposed device can be kept simple in terms of both construction and control technology.

According to a further developed embodiment, the adjustment unit comprises an actuating cylinder or is designed as an actuating cylinder, wherein
a piston is slidably mounted in the actuating cylinder,
the piston divides the actuating cylinder into a first pressure chamber and a second pressure chamber,
the first pressure chamber is connected to the high-pressure line by means of a high-pressure secondary line and a working line,
the second pressure chamber is connected to the hydraulic fluid reservoir by means of a second low-pressure line, and
the piston is biased, with a return spring and/or a counter-piston, against the first pressure chamber.

The high-pressure seat valve connects the high-pressure secondary line and the working line, wherein the working line is arranged downstream of the high-pressure seat valve. Actuating the high-pressure seat valve can influence the pressure level in the working line.

The use of an actuating cylinder as an adjustment unit is technically relatively easy to implement and has proven to be reliable.

According to a further embodiment, a secondary low-pressure line can branch off from the high-pressure secondary line between the high-pressure seat valve and the adjustment unit and open into the second low-pressure line, and a fixed or variable low-pressure throttle can be arranged in the secondary low-pressure line. The term “throttle” shall be understood in the following to include any cross-sectional narrowing in the relevant line. One can therefore also speak of an “atomization” or aperture. The throttle can be fixed or variable. A variable throttle shall be understood to mean that the cross-sectional narrowing can be changed, unlike a fixed throttle. A variable throttle can, for example, specify two or more different cross-sectional narrowings, which can be selected by a user turning a handwheel, for example. However, the selection can also be made with the support of a servo motor or electromagnet operated accordingly by the user. However, this electrical operation can also be activated by the control device and consequently integrated into the control system.

Provided that the adjustment unit, designed as an actuating cylinder, and the piston interact without any leakage, the pressure once built up in the first pressure chamber could no longer decrease. The actuating cylinder would remain in a specific position, so the delivery volume of the hydraulic pump could no longer be changed. As mentioned, this is a purely theoretical consideration, since the piston and the actuating cylinder always inherently have a certain leakage, so that a certain volume of the hydraulic fluid will always flow from the first pressure chamber to the second pressure chamber. A certain amount of leakage is therefore a prerequisite for the proper functioning of the device. However, here too, the leakage leads to a loss of pressure and consequently to reduced efficiency in the operation of the present device. Therefore, efforts are made to minimize leakage, which can be achieved with increased manufacturing accuracy of the piston and the actuating cylinder. However, some residual leakage will always remain. However, the lower the leakage, the slower the pressure in the first pressure chamber can decrease, which has a negative impact on the dynamics of the control system. The low-pressure throttle arranged in the secondary low-pressure line creates an additional path, besides the leakage between the first pressure chamber and the second pressure chamber, through which the pressure in the first pressure chamber can be decreased. This increases the dynamics of the control system.

In a further developed embodiment, a secondary low-pressure line can branch off from the high-pressure secondary line between the high-pressure seat valve and the adjustment unit and open into the second low-pressure line, and a low-pressure seat valve can be arranged in the secondary low-pressure line and can be activated by means of the control device taking into account the actual value detected by the sensor and the target value specified by the actuator. This embodiment differs from the previously discussed embodiments only in that a low-pressure seat valve is used instead of a low-pressure throttle. While a throttle valve cannot be integrated, or is very difficult to integrate, into a control loop, as it is a passive element, the low-pressure seat valve can be integrated into the control loop very well. Therefore, the pressure reduction can be selected very precisely using the secondary low-pressure line. This significantly increases both the dynamics and the precision of the control system compared to a low-pressure throttle.

In a further developed embodiment, the high-pressure seat valve can be designed as a seat valve having integrated pressure limitation. In this embodiment, a pressure limiting function is integrated into the high-pressure seat valve. When the pressure in the hydraulic system, and especially in the consumer, rises above a certain value, the high-pressure seat valve opens independently of any actuation initiated by the control device. As a result, it is ensured that the hydraulic pump pivots back and the pressure in the hydraulic system cannot exceed a certain value, regardless of the functionality of the control device. This protects the components of the hydraulic system.

In a further embodiment, the high-pressure secondary line can have a bypass line that bypasses the high-pressure seat valve. In addition, a pressure relief valve may be arranged in the bypass line. The pressure relief valve can be implemented as a spring-loaded check valve, for example. This also creates a pressure limiting function, which can be provided as an alternative to or in addition to the seat valve having an integrated pressure limiting function. This pressure relief valve prevents an increase in pressure above a certain value, regardless of the functionality of the high-pressure seat valve and its switching state. It should be noted here that, in the context of the present disclosure, the term “pressure relief valve” is used differently from the usual definition, according to which a pressure relief valve is connected directly to the hydraulic reservoir. Apart from the arrangement of the proposed pressure relief valve, there is no difference in function compared to a pressure relief valve as normally defined, however. Alternatively, in this context, this can also be considered a pressure-dependent switching valve.

One embodiment of the invention relates to a device for controlling a hydraulic pump, comprising
a hydraulic fluid reservoir,
a hydraulic pump having one inlet and one outlet, wherein
   the inlet is connected to the hydraulic fluid reservoir by means of a first low-pressure line,
   the outlet is connected to a high-pressure line to which a consumer can be connected,
an adjustment unit interacting with the hydraulic pump and with which the delivery volume of the hydraulic pump can be changed, the adjustment unit being arranged in a high-pressure secondary line connected to the high-pressure line,
a secondary low-pressure line branching off from the high-pressure secondary line,
a low-pressure seat valve arranged in the secondary low-pressure line and interacting with the adjustment unit,
a sensor with which an actual value of at least one characteristic variable that can be influenced by the delivery volume of the hydraulic pump can be detected,
an actuator with which a target value can be specified, and
a control device which interacts with the sensor and the actuator such that the low-pressure seat valve can be activated taking into account the actual value detected by the sensor and the target value specified by the actuator.

In this embodiment, the device does not comprise a high-pressure seat valve, but instead comprises a low-pressure seat valve. The pressure level in the first pressure chamber is therefore always the same as that experienced by the consumer. The delivery volume of the hydraulic pump is mainly influenced by the control of the low-pressure seat valve.

According to a further developed embodiment, the adjustment unit comprises an actuating cylinder or is designed as an actuating cylinder, wherein
a piston is slidably mounted in the actuating cylinder,
the piston divides the actuating cylinder into a first pressure chamber and a second pressure chamber,
the first pressure chamber is connected to the high-pressure line by means of a high-pressure secondary line and a working line,
the second pressure chamber is connected to the hydraulic fluid reservoir by means of a second low-pressure line, and
the piston is biased, with a return spring and/or a counter-piston, against the first pressure chamber.

The use of an actuating cylinder as an adjustment unit is technically relatively easy to implement and has proven to be reliable.

In a further embodiment, it may be provided that a fixed or variable high-pressure throttle is arranged in the high-pressure secondary line. In this case, the pressure in the first pressure chamber is not automatically the same as at the consumer, but rather, depending on the system state, is the reduced pressure level. The pressure load of the actuating cylinder is correspondingly lower.

One embodiment of the invention relates to a device for controlling a hydraulic motor, comprising
a hydraulic fluid pressure reservoir,
a hydraulic motor having one inlet and one outlet, wherein
   the inlet is connected to the hydraulic fluid pressure reservoir by means of a high-pressure line,
   the outlet is connected to a hydraulic fluid reservoir by means of a return line,
an adjustment unit interacting with the hydraulic motor and with which the displacement volume to be absorbed by the hydraulic motor can be changed,
a high-pressure seat valve arranged in the high-pressure secondary line and interacting with the adjustment unit,
a sensor with which an actual value of at least one characteristic variable that can be influenced by the displacement volume to be absorbed by the hydraulic motor can be detected,
an actuator with which a target value can be specified, and
a control device which interacts with the sensor and the actuator such that the high-pressure seat valve can be activated taking into account the actual value detected by the sensor and the target value specified by the actuator.

The displacement volume of the hydraulic motor is analogous to the delivery volume of the hydraulic pump. The displacement volume can influence the power or torque delivered by the hydraulic motor.

One implementation of the invention relates to a device for controlling a hydraulic motor, comprising
a hydraulic fluid pressure reservoir,
a hydraulic motor having one inlet and one outlet, wherein
   the inlet is connected to the hydraulic fluid pressure reservoir by means of a high-pressure line,
   the outlet is connected to a hydraulic fluid reservoir by means of a return line,
an adjustment unit interacting with the hydraulic motor and with which the displacement volume to be absorbed by the hydraulic motor can be changed, the adjustment unit being arranged in a high-pressure secondary line connected to the high-pressure line,
a low-pressure seat valve arranged in the secondary low-pressure line and interacting with the adjustment unit,
a sensor with which an actual value of at least one measurement unit that can be influenced by the displacement volume to be absorbed by the hydraulic motor and relates to the consumer can be detected,
an actuator with which a target value of the characteristic variable can be specified, and
a control device which interacts with the sensor and the actuator such that the low-pressure seat valve can be activated taking into account the actual value detected by the sensor and the target value specified by the actuator.

The technical effects and advantages that can be achieved with the proposed device for controlling a hydraulic motor are the same as those that have been discussed for the present device for controlling a hydraulic pump. In summary, it should be noted that, on the one hand, the leakage within the device can be significantly reduced compared to controllers known from the prior art, thereby increasing the efficiency and dynamics of the control system. On the other hand, various control tasks and control characteristics can be implemented flexibly and quickly without changing the hydraulic components of the device. Furthermore, a large number of parameters can be taken into account in the control system, thereby increasing the accuracy of the control system. These parameters can be detected using additional sensors.

According to a further implementation of the invention,
the high-pressure seat valve is designed as a high-pressure digital seat valve and/or
the low-pressure seat valve is designed as a low-pressure digital seat valve and/or
the high-pressure seat valve having an integrated pressure limiting function is designed as a high-pressure digital seat valve having an integrated pressure limiting function.

Digital seat valves have the following properties in particular: They are completely or almost completely leak-free in the closed state, so that in the closed state they cause no or almost no leakage in the present device, and in the open switching state have larger opening cross-sections compared to conventional standard controllers. As a result, the dynamics and efficiency of the control system can be improved. The improved dynamics lead to better responsiveness of the actuator in question and to increased ease of use. Not only do digital seat valves include two switching states (open and closed), but they can also be used for metering when appropriately controlled using the electronics of the control unit. Furthermore, they exhibit very short switching times of 5 ms and less. The volume flow of the hydraulic fluid through the digital seat valve in question can be adjusted very precisely with the frequency of opening and closing. Besides the aforementioned pulse width modulation, there are also other control variants such as frequency modulation or combinations thereof.

Furthermore, digital seat valves can be actuated with a control device, which may include power electronics. The control device is able to take into account a large number of parameters when actuating the digital seat valves in order to match the actual value of the characteristic variable, for example the volume flow of the hydraulic fluid, as closely as possible to the target value specified by the actuator. The actual value can be detected with the sensor. The actuator can be designed, for example, as an operating lever of an excavator. The control system is significantly improved compared to controllers known from the prior art.

As mentioned, depending on the design, a leak-free actuating cylinder can be used. Technically, a nearly leak-free actuating cylinder can be provided by arranging appropriate seals on the piston, sealing the piston against the actuating cylinder. As also mentioned, the pressure loss associated with the leakage during operation of the present device could then be significantly reduced or completely eliminated, resulting in an increase in efficiency. However, a seal creates increased friction in the actuating cylinder, which means that the frictional forces of the seal must be overcome to move the piston. This can lead to delayed responsiveness. To counteract this, the digital seat valves can be actuated by the control device with a so-called “boost and hold” strategy. The pulsed control results in pulse-like pressure increases in the first pressure chamber and in the second pressure chamber, which enables precise adjustment of the piston despite the occurrence of static/sliding friction (stick-slip effect).

In a further development of the invention, a pressure present in the working line can be detected by means of a pressure sensor, the pressure sensor interacting with the control device such that the high-pressure seat valve and/or the low-pressure seat valve can be activated taking into account the pressure detected by the pressure sensor. This allows the pressure in the working line to be included as an additional variable in the control of the system. The pressure detected in the working line is the pressure applied to the adjustment unit. By including the pressure in the working line in the control system, the adjustment unit can be influenced more directly by the control device. The adjustment unit typically sets the delivery volume of the hydraulic pump or the displacement volume of the hydraulic motor. If further parameters of the hydraulic pump or hydraulic motor are known, the device further developed in this manner can impose any desired delivery volume on the hydraulic pump or any desired displacement volume on the hydraulic motor. The hydraulic power of the hydraulic pump can thus be matched to the power of the drive motor. If the device is designed to control a hydraulic motor, the hydraulic power of the hydraulic motor can be matched to the power drawn from the shaft.

The control device can be designed to determine a position of the adjustment unit based on the pressure detected by the pressure sensor, wherein the high-pressure seat valve and/or the low-pressure seat valve can be activated taking into account the position of the adjustment unit determined by the control device. If the adjustment unit is designed as an actuating cylinder, the position of the adjustment unit is preferably described by the position of the piston in the actuating cylinder. Furthermore, the position of the piston can be used to determine the pivot angle of the hydraulic pump or hydraulic motor. Therefore, such an arrangement allows the pivot angle to be detected without the need for a pivot angle sensor. This allows for a simpler design of the hydraulic pump or hydraulic motor. Furthermore, this allows for active influencing of the pivot angle.

According to a further development of the invention, the high-pressure seat valve and/or the low-pressure seat valve can be activated by the control device using an activation variable. In this process, a reference value of the activation variable can be stored in the control device, depending on the actual value of a characteristic variable that can be influenced by the delivery volume of the hydraulic pump or by the displacement volume to be absorbed by the hydraulic motor. The control device is preferably designed to detect an actual value of the activation variable corresponding to the actual value of the characteristic variable and to determine a state characteristic value of the hydraulic pump or hydraulic motor from the comparison of the actual value of the activation variable to a reference value of the activation variable associated with the actual value of the characteristic variable. A particular advantage of such a further development of the invention is that no further components are necessary for its realization, but instead it is only necessary for the control device to be adapted accordingly.

A method for controlling the hydraulic pump of the hydraulic motor, wherein the high-pressure seat valve and/or a low-pressure seat valve can be activated using an activation variable, comprises the following steps:
detecting the actual value of at least one characteristic variable that can be influenced by the delivery volume of the hydraulic pump or by the displacement volume to be absorbed by the hydraulic motor,
detecting a corresponding actual value of the activation variable,
determining a state characteristic value of the hydraulic pump or hydraulic motor by comparing the actual value of the activation variable to a reference value of the activation variable associated with the actual value of the characteristic variable.

As mentioned previously, the characteristic variable can be the volume flow rate of the hydraulic fluid. The activation variable can be determined by the strength of a control current and/or a control duration of the high-pressure seat valve and/or the low-pressure seat valve, or their activation frequencies and/or period. Typically, the control current has a periodic profile, with the strength of the control current changing during a period. The duration during which the control current is strong enough to normally cause the valve to open is referred to here and in the following as the control duration. For example, in the control device, a reference relationship between the volume flow rate and the strength of the control current and/or the control duration can be stored, so that for a certain volume flow rate the actual value of the control current and/or the control duration can be compared to a corresponding reference value. The reference relationship can be stored, for example, in the form of a characteristic curve or a characteristic map. The state characteristic value can, for example, be specified in the form of a percentage deviation.

Typically, the hydraulic pump or hydraulic motor exhibits increased leakage as it wears down. In order to achieve the same effective delivery volume in the case of the hydraulic pump or the same mechanical power in the case of the hydraulic motor, the high-pressure seat valve, for example, must consequently be opened more frequently or further. The state characteristic value can therefore be used as an indicator about the wear condition of the hydraulic pump or hydraulic motor.

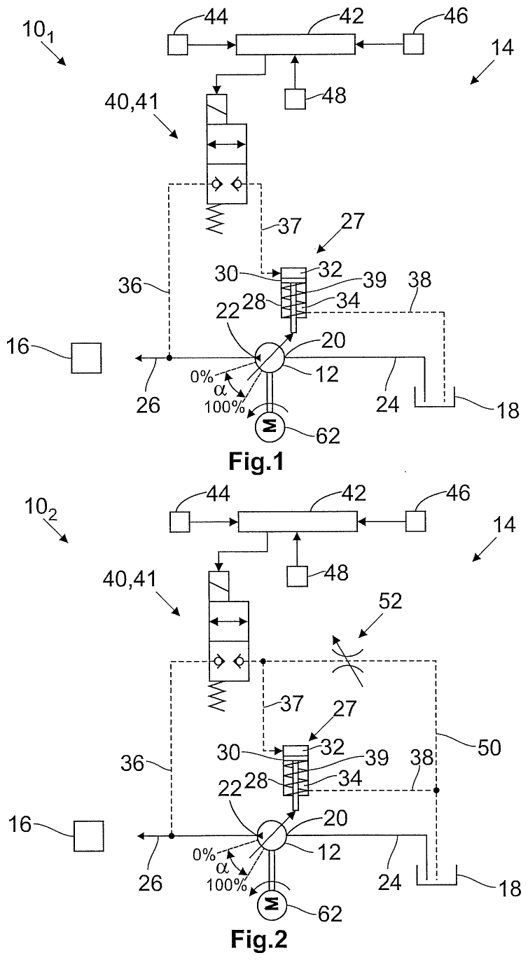

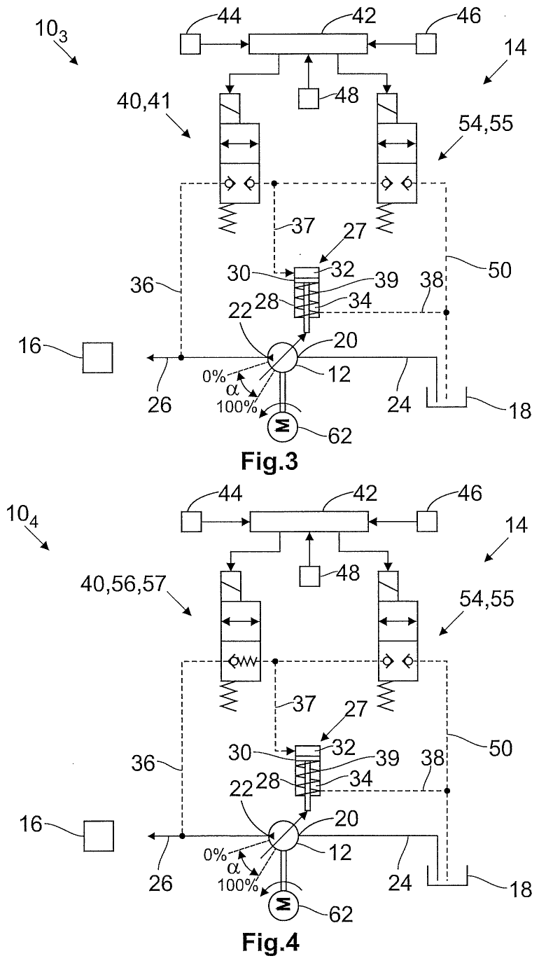

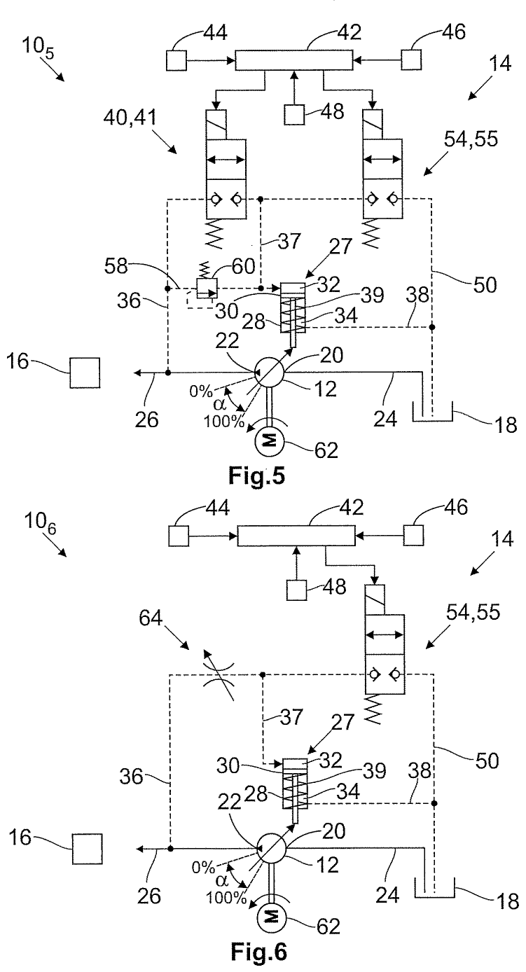

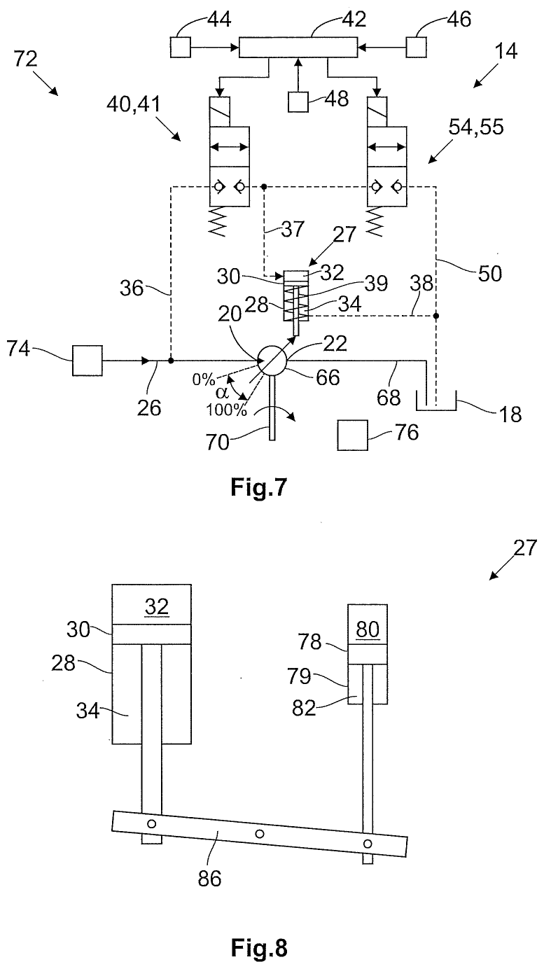

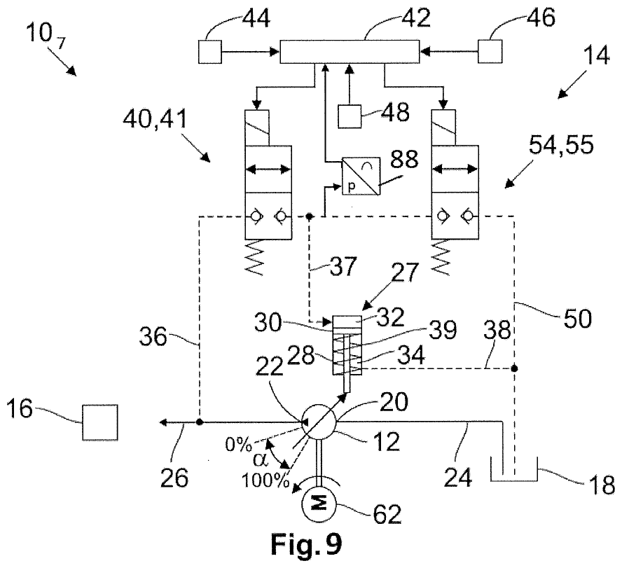

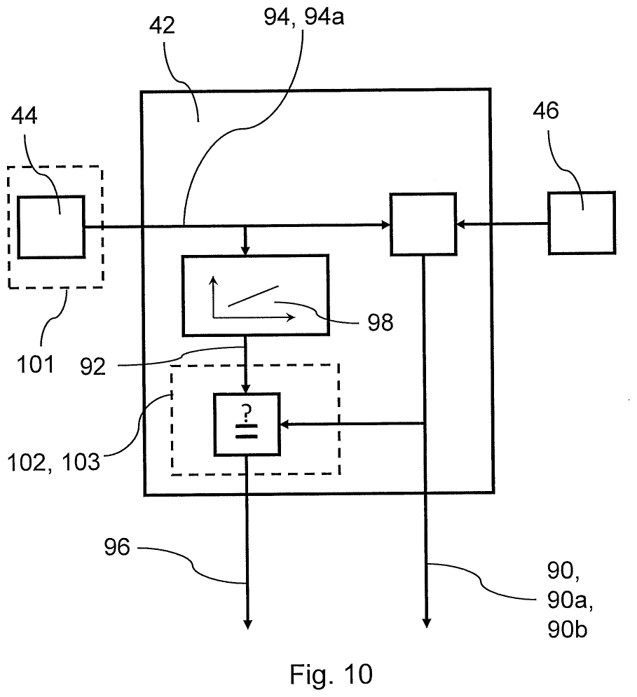

Exemplary embodiments of the invention are explained in more detail below with reference to the accompanying drawings. In the drawings:
FIG. 1 shows a first exemplary embodiment of a proposed device for controlling a hydraulic pump having a high-pressure seat valve;
FIG. 2 shows a second exemplary embodiment of a proposed device for controlling a hydraulic pump having a high-pressure seat valve and throttle;
FIG. 3 shows a third exemplary embodiment of a proposed device for controlling a hydraulic pump having a high-pressure seat valve and a low-pressure seat valve;
FIG. 4 shows a fourth exemplary embodiment of a proposed device for controlling a hydraulic pump having a high-pressure seat valve and a low-pressure seat valve including pressure limitation;
FIG. 5 shows a fifth exemplary embodiment of a proposed device for controlling a hydraulic pump having a high-pressure seat valve and a low-pressure seat valve including pressure limitation;
FIG. 6 shows a sixth exemplary embodiment of a proposed device for controlling a hydraulic pump having a low-pressure seat valve and a high-pressure throttle;
FIG. 7 shows an exemplary embodiment of a proposed device for controlling a hydraulic motor;
FIG. 8 shows a basic representation of a second embodiment of the adjustment unit;
FIG. 9 shows a seventh exemplary embodiment of a proposed device for controlling a hydraulic pump having a high-pressure seat valve and a low-pressure seat valve, including pressure limitation and pressure sensor; and
FIG. 10 shows a basic representation of an embodiment of the control device for carrying out a method for controlling a hydraulic pump or a hydraulic motor.

FIG. 1 uses a basic circuit diagram to show a first exemplary embodiment of a proposed device 101 for controlling a hydraulic pump 12. The device 101 is part of a hydraulic system 14 with which an unspecified consumer 16 can be actuated and which may include hydraulic components not shown, such as valves, apertures and the like. For example, the consumer 16 can be a hydraulic cylinder used to move a component of construction equipment, for example.

The device 101 comprises a hydraulic fluid reservoir 18 in which a hydraulic fluid, in particular hydraulic oil, can be stored. Furthermore, the device 101 comprises a hydraulic pump 12 equipped with an inlet 20 and an outlet 22. The inlet 20 of the hydraulic pump 12 is connected to the hydraulic fluid reservoir 18 by means of a first low-pressure line 24, so that the hydraulic pump 12 can draw the hydraulic fluid from the hydraulic fluid reservoir 18. Furthermore, the outlet 22 of the hydraulic pump 12 is connected to the aforementioned consumer 16 by means of a high-pressure line 26. As a result, the hydraulic fluid drawn in by the hydraulic pump 12 can be conveyed to the consumer 16 and pressure can be built up there due to resistance from the hydraulic system or the consumer 16.

Furthermore, the device 101 comprises an adjustment unit 27 that interacts with the hydraulic pump 12 and can be structurally integrated into the hydraulic pump 12. The adjustment unit 27 can change the delivery volume of the hydraulic pump 12, that is, the volume flow provided by the hydraulic pump 12. In the illustrated exemplary embodiment, the adjustment unit 27 is designed as an actuating cylinder 28 with which the so-called pivot angle α can be changed. The pivot angle a can be changed so that the delivery volume of the hydraulic pump 12 is changed between 0% (theoretical) and 100%. The term “pivot angle” is commonly used for axial piston pumps; however, the use of the present device 10₁ is not limited to the control of axial piston pumps. The actuating cylinder 28 has a piston 30 which is axially displaceable in the actuating cylinder 28 and divides the actuating cylinder 28 into a first pressure chamber 32 and a second pressure chamber 34. The first pressure chamber 32 is connected to the high-pressure line 26 by means of a high-pressure secondary line 36 and a working line 37, while the second pressure chamber 34 is connected to the housing of the hydraulic pump 12, directly or indirectly, by means of a second low-pressure line 38 with the aforementioned hydraulic fluid reservoir 18. The second low-pressure line 38 can also be referred to as a leakage or tank line. The piston 30 is biased towards the first pressure chamber 32 with a return spring 39.

Furthermore, a high-pressure seat valve 40, in the present exemplary embodiment designed as a high-pressure digital seat valve 41, is arranged in the high-pressure secondary line 36 and can be actuated with a control device 42, for which electrical lines are used. The pressure level in the downstream part of the high-pressure secondary line 36 can be influenced by actuating the high-pressure seat valve 40. This part of the high-pressure secondary line 36 is also referred to below as working line 37.

Using electrical lines, the control device 42 in turn is connected to at least one sensor 44 with which an actual value of a characteristic variable can be determined and supplied to the control device 42, which is to be changed with the delivery volume of the hydraulic pump 12. Furthermore, using electrical lines, the control device 42 is connected to an actuator 46 with which the target value of the characteristic variable can be specified. The actuator 46 can be designed as an operating lever of the construction equipment, for example.

The control device 42 can also be connected by means of electrical lines to one or a plurality of further sensors 48 with which parameters that may have an influence on the control system can be detected. The parameters can be taken into account by the control device 42 when the high-pressure seat valve 40 is actuated in order to be able to adjust the actual value to the target value more quickly. The sensor 44 and the other sensors 48 as well as the actuator 46 provide their signals in electronic form to the control device 42. Wireless connections can also be used instead of electrical wiring.

The proposed device 10₁ is operated in the following manner: First, a drive motor 62 is switched on for the hydraulic pump 12, thereby activating the hydraulic pump 12. The hydraulic pump 12 delivers the hydraulic fluid from the hydraulic fluid reservoir 18 to the consumer 16, in which a certain pressure builds up due to resistance and the delivery of the fluid. This pressure is also present in the high-pressure line 26 and in the high-pressure secondary line 36, upstream of the high-pressure seat valve 40 as viewed in the direction of flow. The working line 37 is designed with a lower pressure than the high-pressure secondary line 36 in order to generate equilibrium of forces within the adjustment unit 27. The user of the construction equipment, for example, can now use the actuator 46 to specify a certain target value of the characteristic variable, which may correspond, for example, to a certain volume flow rate of the hydraulic fluid in the consumer 16. This target value is fed to the control device 42. At the same time, the actual value of the characteristic variable in the consumer 16 or at another suitable point in the hydraulic system 14 is detected by the sensor 44. To adjust the actual value to the target value, the high-pressure seat valve 40 is now actuated by the control device 42. As can be seen from FIG. 1, the high-pressure seat valve 40 is a 2/2 seat valve which can be moved between an open position and a closed position. Furthermore, it can be seen from FIG. 1 that the high-pressure seat valve 40 is normally closed, i.e., designed as a “normally closed” valve. Due to the fact that the high-pressure seat valve 40 is designed as a seat valve, it is leak-free in the closed state.

It is assumed in the following that the high-pressure seat valve 40 is initially not actuated by the control device 42. As a result, the high-pressure seat valve 40 is closed. The pressure that is built up in the consumer 16 and consequently in the high-pressure line 26 and in the high-pressure secondary line 36 up to the high-pressure seat valve 40 is therefore not passed on into the first pressure chamber 32. The return spring 39, with which the piston 30 is pre-loaded, is therefore in a state corresponding to the minimum spring pre-load. In this state, the actuating cylinder 28 interacts with the hydraulic pump 12 such that the latter assumes its maximum pivot angle α or delivers its maximum delivery volume. Due to resistance from the consumer 16 or the hydraulic system and the continued delivery of the hydraulic fluid, the pressure continues to increase in the consumer 16, in the high-pressure line 26 and in the high-pressure secondary line 36. This pressure increase is detected by the sensor 44. If the control device 42 determines that the actual value does not correspond to the target value, the delivery volume of the hydraulic pump 12 can be reduced. To this end, the control device 42 opens the high-pressure seat valve 40, so that the hydraulic fluid can flow through the high-pressure seat valve 40 to the first pressure chamber 32. The volume in the first pressure chamber 32 can be adjusted as a result of the pulse width with which the high-pressure seat valve 40 is opened and closed. Due to the increasing volume in the first pressure chamber 32, the pressure there increases, causing the piston 30 to be moved towards the second pressure chamber 34 and the return spring 39 to be compressed. Due to the movement of the piston, the pivot angle a and consequently the delivery volume of the hydraulic pump 12 are reduced. Once the actual value matches the target value, the delivery volume is no longer changed.

The position of the piston would be maintained provided that the piston 30 seals the first pressure chamber 32 and the second pressure chamber 34 against each other without leakage. This would also mean that the delivery volume of the pump could not be increased again. However, due to the nature of the system, there is always a certain leakage between the first pressure chamber 32 and the second pressure chamber 34, so that a certain volume can flow from the first pressure chamber 32 into the second pressure chamber 34. Due to this leakage, the volume of the hydraulic fluid in the first pressure chamber 32 decreases more or less rapidly, and as a result the piston 30 is moved back to the first pressure chamber 32 by the return spring 39. This movement results in an increase in the adjustment angle and consequently an increase in the delivery volume of the hydraulic pump 12. This would cause the actual value to deviate from the target value again. To counteract this, the control device 42 opens the high-pressure seat valve 40 such that the actual value corresponds to the target value.

In the event that the user of the construction equipment wishes to perform a faster cylinder movement, for example, the delivery volume of the hydraulic pump 12 must be increased. In the exemplary embodiment shown in FIG. 1, this is achieved exclusively via the leakage, which, as already mentioned, allows a flow of the hydraulic fluid from the first pressure chamber 32 into the second pressure chamber 34. As also described, the return spring 39 returns the piston 30 to the first pressure chamber 32, thereby increasing the pivot angle α or the delivery volume. In this way, the hydraulic pump 12 can be controlled accordingly. It should be mentioned at this point that with the additional sensor 48, parameters that also have an influence on the control system can be incorporated into the control system.

FIG. 2 shows a second exemplary embodiment of the proposed device 102, also illustrated using a basic circuit diagram. The construction of the device 102 according to the second exemplary embodiment largely corresponds to that of the first exemplary embodiment of the device 10₁ shown in FIG. 1, wherein, in addition, a secondary low-pressure line 50 branches off from the high-pressure secondary line 36 between the high-pressure seat valve 40 and the actuating cylinder 28 and opens into the second low-pressure line 38. A low-pressure throttle 52 is arranged in this secondary low-pressure line 50. The secondary low-pressure line 50 allows the hydraulic fluid to flow from the first pressure chamber 32 into the hydraulic fluid reservoir 18 without having to flow between the piston 30 and the actuating cylinder 28 into the second pressure chamber 34. The actuating cylinder 28 could therefore be designed to be leak-free, which is inherently not possible. However, leakage can be reduced by appropriate manufacturing accuracy. Reduced leakage keeps the pressure loss in hydraulic system 14 low, thereby increasing the efficiency with which hydraulic system 14 can be operated.

As already mentioned, in order to increase the pivot angle α or the delivery volume of the hydraulic pump 12, the piston 30 must be moved towards the first pressure chamber 32, wherein a certain volume of the hydraulic fluid must be discharged from the first pressure chamber 32. While in the first exemplary embodiment of the proposed device 101, which is shown in FIG. 1, the hydraulic fluid only has the path from the first pressure chamber 32 into the second pressure chamber 34, in the second exemplary embodiment the hydraulic fluid can also flow out of the first pressure chamber 32 through the secondary low-pressure line 50 and the low-pressure throttle 52. Since in the second exemplary embodiment the hydraulic fluid can flow out of the first pressure chamber 32 more quickly, the control becomes more dynamic, thereby improving the responsiveness.

FIG. 3 shows a third exemplary embodiment of the proposed device 10₃, also illustrated using a basic circuit diagram. The device 10₃ according to the third exemplary embodiment is largely the same as the device 10₂ according to the second exemplary embodiment shown in FIG. 2; however, a low-pressure seat valve 54, rather than the low-pressure throttle 52, is arranged in the secondary low-pressure line 50, is also designed as a low-pressure digital seat valve 55 and, like the high-pressure seat valve 40, can be actuated by the control device 42. In the third exemplary embodiment, the outflow of the hydraulic fluid from the first pressure chamber 32 can be influenced in a much more targeted manner than in the second exemplary embodiment, since the volume flow of the hydraulic fluid flowing out of the first pressure chamber 32 can be predetermined with a corresponding activation of the low-pressure seat valve 54. Therefore, if, for example, an increased target value of the relevant characteristic variable is requested in the consumer 16 using the actuator 46, the control device 42 can open the low-pressure seat valve 54 accordingly, thereby increasing the pivot angle α or the delivery volume of the hydraulic pump 12.

FIG. 4 shows a fourth exemplary embodiment of the proposed device 10₄, which largely corresponds to the third exemplary embodiment according to FIG. 3. The essential difference is that the high-pressure seat valve 40 is designed as a high-pressure seat valve 56 having an integrated pressure limitation, in this case as a high-pressure digital seat valve 57 having an integrated pressure limitation function. The high-pressure seat valve 40 therefore has a pressure limiting function, the value of which can be varied depending on system specifications. If the pressure in the consumer 16 and consequently in the high-pressure line 26 and the high-pressure secondary line 36 up to the high-pressure seat valve 40 exceeds a certain value, the high-pressure seat valve 40 opens regardless of whether or not it is activated accordingly by the control device 42. As a result of the opening of the high-pressure digital seat valve 40, the hydraulic fluid flows into the first pressure chamber 32, which moves the piston 30 towards the second pressure chamber 34 as described above and consequently reduces the pivot angle α or the delivery volume of the hydraulic pump 12. The pressure in the supply line therefore cannot exceed the maximum pump pressure. This prevents damage to the hydraulic components of the hydraulic system 14.

FIG. 5 shows a fifth exemplary embodiment of the proposed device 10₅, which largely corresponds to the third exemplary embodiment according to FIG. 3. However, a bypass line 58 is provided in the high-pressure secondary line 36 and allows the high-pressure seat valve 40 to be bypassed. The hydraulic fluid can therefore flow into the first pressure chamber 32 both through the high-pressure seat valve 40 and through the bypass line 58. A pressure relief valve 60 is arranged in the bypass line 58. As already described for the fourth exemplary embodiment of the inventive device 10₄ shown in FIG. 4, the pressure relief valve 60 of the bypass line 58 also opens when the pressure in the high-pressure line 26 and the high-pressure secondary line 36 exceeds a certain value. Again, the pivot angle α and the delivery volume of the hydraulic pump 12 are reduced as a result of the opening of the pressure relief valve 60, so that the pressure in the hydraulic system 14 is limited.

FIG. 6 shows a sixth exemplary embodiment of the proposed device 10₆, in which the high-pressure secondary line 36 opens directly into the first pressure chamber 32, without a high-pressure seat valve 40 being arranged in the high-pressure secondary line 36. However, a high-pressure throttle 64 is arranged in the high-pressure secondary line 36. A low-pressure seat valve 54 is arranged in the secondary low-pressure line 50 and, as in the relevant exemplary embodiments described above, can be actuated by the control device 42. The device 10₆ according to the sixth exemplary embodiment is operated as follows: As a result of the hydraulic fluid being delivered from the hydraulic reservoir 18 to the consumer 16, the pressure in the consumer 16, which is also present in the high-pressure secondary line 36, increases. However, the pressure in the first pressure chamber 32 is not the same as that in the high-pressure line 26 and the consumer 16, but rather is the pressure reduced accordingly by the high-pressure throttle 64. However, the reduced pressure in the first pressure chamber 32 also leads, as already described several times, to a reduction in the pivot angle α and the delivery volume of the hydraulic pump 12. To increase the pivot angle α and the delivery volume, the low-pressure seat valve 54 is opened accordingly by the control device 42.

FIG. 7 shows a device 72 for controlling a hydraulic motor 66, wherein the device 72 largely corresponds to the device 103 for controlling a hydraulic pump 12 according to the third exemplary embodiment shown in FIG. 3. In this case, however, the high-pressure line 26 is not connected to a consumer 16, but instead is connected to a hydraulic fluid pressure reservoir 74 in which the hydraulic fluid is kept at a certain pressure. The high-pressure line 26 is connected to the inlet 20 of the hydraulic motor 66. The outlet 22 of the hydraulic motor 66 is connected to the hydraulic fluid reservoir 18 by means of a return line 68. The hydraulic fluid therefore flows from the hydraulic fluid pressure reservoir 74 to the hydraulic fluid reservoir 18, flowing through the hydraulic motor 66 in the process. A shaft 70 is driven during this flow and in turn is connected to a consumer 76. The power transmitted by the shaft 70 can be used to operate the consumer 76 in the desired manner. Furthermore, the control of the hydraulic motor 66 or the power it delivers is carried out in the same way as has been described for the device 10₃ for controlling the hydraulic pump 12 according to the third exemplary embodiment. All exemplary embodiments of the device 10₁ to 10₆ for controlling the hydraulic pump 12 can also be used analogously as a device 72 for controlling the hydraulic motor 66.

In all of the exemplary embodiments, the control device 42 can include power electronics which can be operated with software. This software may contain algorithms that simulate different control characteristics. As a result, the control device 42 can be operated, for example, as a PI controller, a PID controller or one of the aforementioned in combination with fixed-value control. The different control characteristics can be selected on the control device 42, depending on the application. No adjustment or replacement of the components of the device 10 is necessary. Furthermore, the number of sensors 44 and additional sensors 48 is not limited. The measurement units they measure can also be chosen largely freely, the only restriction being that it must be possible for the hydraulic pump 12 or the hydraulic motor 66 to also be able to actually influence the measurement units determined by the sensors 44.

It should be noted at this point that the terms “high-pressure line,” “low-pressure line” and the like are not to be understood as meaning that there must always be high pressure or low pressure present there. These terms primarily serve to distinguish the relevant components of the present devices 10 and 72.

In FIGS. 1 to 7 and 9, when present, the high-pressure secondary line 36, the working line 37, the second low-pressure line 38, the secondary low-pressure line 50 and the bypass line 58 are shown as dashed lines. This is intended to symbolize that these lines are control lines used to control the hydraulic pump 12 or the hydraulic motor 66 and not primarily to supply the consumer 16 with hydraulic fluid.

Furthermore, open circuits with and without pre-charged tank pressure are shown in FIGS. 1 to 7 and 9; however, the proposed device for controlling a hydraulic pump 12 or the hydraulic motor 66 can also be used for closed circuits.

FIG. 8 shows a second exemplary embodiment of the adjustment unit 27 in a schematic representation. While according to the first embodiment the piston 30 of the adjustment unit 27 is biased against the first pressure chamber 32 with the return spring 39 as mentioned, in the second embodiment of the adjustment unit 27 a counter-piston 78, slidably mounted in a counter-cylinder 79, is used for this purpose. To ensure that the function of the adjustment unit 27 is maintained even at lower pressures, the effective surface of the counter-cylinder 79 is smaller than that of the actuating cylinder 28, for example in a ratio of 1:4. The counter-piston 78 closes off a first counter-pressure chamber 80. The piston 30 is connected to the counter-piston 78 via a rotatably mounted connecting rod 86, which in the example of the axial piston pump represents a pivot cradle. If the piston 30 is moved to the second pressure chamber 34 due to an increase in pressure in the first pressure chamber 32, the connecting rod 86 transmits this movement to the counter-piston 78 such that the counter-piston 78 is moved in the opposite direction towards the first counter-pressure chamber 80. The medium contained therein, which may correspond to the hydraulic fluid of the rest of the device 10, is thereby displaced. With the active supply of the medium to the first counter-pressure chamber 80, the piston 30 is moved again towards the first pressure chamber 32.

It is conceivable for the counter-piston 78 to divide the counter-cylinder 79 into the aforementioned first counter-pressure chamber 80 and a second counter-pressure chamber 82. The first counter-pressure chamber 80 and the second counter-pressure chamber 82 can be integrated into the device 10 so that the pressures in the first counter-pressure chamber 80 and in the second counter-pressure chamber 82 can be specifically changed in order to realize certain control characteristics. The piston 30 and the counter-piston 78 have a specific surface ratio to generate dominance of one piston 30 at the same pressure level. The combination of counter-piston 78 with an additional spring for resetting the piston 30 is also feasible (not shown).

FIG. 9 shows a seventh exemplary embodiment of the proposed device 10₇, which largely corresponds to the fourth exemplary embodiment according to FIG. 3. The main difference is that the pressure present in the working line 37 can be detected by means of a pressure sensor 88. The pressure sensor 88 interacts with the control device 42 such that the high-pressure seat valve 40 and/or the low-pressure seat valve 54 can be activated taking into account the pressure detected by the pressure sensor 88. Thus, the pressure in the working line 37 can be included as an additional variable in the control of the system. The pressure detected in the working line 37 corresponds to the pressure applied to the adjustment unit 27. By including the pressure in the working line 37 in the control system, the adjustment unit 27 can be influenced more directly by the control device 42. The adjustment unit 27 usually sets the delivery volume of the hydraulic pump 12. If further parameters of the hydraulic pump are known, the device further developed in this manner can impose any desired delivery volume on the hydraulic pump 12. The hydraulic power of the hydraulic pump 12 can thus be matched to the power of the drive motor 62.

The control device 42 can be designed to determine the position of the piston 30 in the actuating cylinder 28 using the pressure detected by the pressure sensor 88, so that the high-pressure seat valve 40 and/or the low-pressure seat valve 54 can be activated taking into account the position of the piston 30 determined by the control device 42. The pivot angle α of the hydraulic pump 12 can also be determined via the position of the piston 30. Therefore, such an arrangement allows the pivot angle α to be detected without the need for a pivot angle sensor. This allows for a simpler design of the hydraulic pump 12. Furthermore, this allows for active influencing of the pivot angle α.

The detection of the pressure present in the working line 37 and the interaction of the pressure sensor 88 with the control device 42 can be applied to the exemplary embodiments shown in FIGS. 1, 2 and 4 to 6 in the manner described above. The pressure sensor 88 can also interact with the control device 42 such that the high-pressure seat valve 40 and/or the low-pressure seat valve 54 can be activated taking into account the pressure detected by the pressure sensor 88.

If the device, as shown in FIG. 7, is designed to control a hydraulic motor 66, the pressure present in the working line 37 can be detected accordingly by means of the pressure sensor 88. According to the description of the exemplary embodiment in FIG. 9, any desired displacement volume can be imposed on the hydraulic motor 66. The hydraulic power of the hydraulic motor 66 can thus be matched to the power drawn at the shaft 70. The pivot angle α of the hydraulic motor 66 can also be detected and actively influenced in a corresponding manner.

In each of the previously described exemplary embodiments, the high-pressure seat valve 40 and/or the low-pressure seat valve 54 can be activated by the control device 42 using an activation variable as shown in FIG. 10. In this process, a reference value 92 of the activation variable can be stored in the control device 42, depending on the actual value 94 of a characteristic variable that can be influenced by the delivery volume of the hydraulic pump 12 or by the displacement volume to be absorbed by the hydraulic motor 66. The control device 42 is preferably designed to detect the actual value 94 of the characteristic variable and a corresponding actual value 90 of the activation variable and to determine a state characteristic value 96 of the hydraulic pump 12 or the hydraulic motor 66 from the comparison of the actual value 90 of the activation variable to the reference value 92 of the activation variable associated with the actual value 94 of the characteristic variable. A particular advantage of such a further development of the invention is that no further components are necessary for its realization, but instead it is only necessary for the control device 42 to be adapted accordingly.

A method for controlling the hydraulic pump 12 of the hydraulic motor 66, wherein the high-pressure seat valve 40 and/or a low-pressure seat valve 54 can be activated using an activation variable, comprises a first step 101 in which the actual value 94 of at least one characteristic variable that can be influenced by the delivery volume of the hydraulic pump 12 or by the displacement volume to be absorbed by the hydraulic motor 66 is detected. In a second step 102, an actual value 90 of the activation variable corresponding to the actual value of the characteristic variable is also detected in order to determine in a third step 103 a state characteristic value 96 of the hydraulic pump 12 or the hydraulic motor 66 by comparing the actual value 90 of the activation variable to a reference value 92 of the activation variable associated with the actual value 94 of the characteristic variable.

The characteristic variable can be the volume flow rate of the hydraulic fluid. The activation variable can be determined by the strength of a control current and/or a control duration of the high-pressure seat valve and/or the low-pressure seat valve, or their activation frequencies and/or period. Accordingly, in the control device 42, a reference relationship 98 between an actual volume flow 94a and an actual strength 90a of the control current and/or an actual control duration 90b can be stored, so that for a certain value of the actual volume flow 94a the actual strength 90a of the control current and/or the actual control duration 90b can be compared to a corresponding reference value 92.

The state characteristic value 96 can be specified, for example, in the form of a percentage deviation.

### LIST OF REFERENCE SYMBOLS

10 Device
10₁-10₇ Device
12 Hydraulic pump
14 Hydraulic system
16 Consumer
18 Hydraulic reservoir
20 Inlet
22 Outlet
24 First low-pressure line
26 High-pressure line
27 Adjustment unit
28 Actuating cylinder
30 Piston
32 First pressure chamber
34 Second pressure chamber
36 High-pressure secondary line
37 Working line
38 Second low-pressure line
39 Return spring
40 High-pressure seat valve
41 High-pressure digital seat valve
42 Control device
44 Sensor
46 Actuator
48 Additional sensor
50 Secondary low-pressure line
52 Low-pressure throttle
54 Low-pressure seat valve
55 Low-pressure digital seat valve
56 High-pressure seat valve with integrated pressure limitation
57 High-pressure digital seat valve with integrated pressure limitation
58 Bypass line
60 Pressure relief valve
62 Drive motor
64 High-pressure throttle
66 Hydraulic motor
68 Return line
70 Shaft
72 Device
74 Hydraulic pressure reservoir
76 Consumer
78 Counter-piston
79 Counter-cylinder
80 First counter-pressure chamber
82 Second counter-pressure chamber
86 Connecting rod
88 Pressure sensor
90 Actual value of the activation variable
90a Actual strength of the control current
90b Actual control duration
92 Reference value of the activation variable
94 Actual value of the characteristic variable
94a Actual volume flow rate
96 State characteristic value
98 Reference relationship
101 First step
102 Second step
103 Third step
α Pivot angle

1. A device (10) for controlling a hydraulic pump (12), comprising
a hydraulic fluid reservoir (18),
a hydraulic pump (12) having one inlet (20) and one outlet (22), wherein
the inlet (20) is connected to the hydraulic fluid reservoir (18) by means of a first low-pressure line (24),
the outlet (22) is connected to a high-pressure line (26) to which a consumer (16) can be connected,
an adjustment unit (27) interacting with the hydraulic pump (12) and with which the delivery volume of the hydraulic pump (12) can be changed, the adjustment unit (27) being arranged in a high-pressure secondary line (36) connected to the high-pressure line (26),
a high-pressure seat valve (40) arranged in the high-pressure secondary line (36) and interacting with the adjustment unit (27),
a sensor with which an actual value of at least one characteristic variable that can be influenced by the delivery volume of the hydraulic pump (12) can be detected,
an actuator (46) with which a target value of the characteristic variable can be specified, and
a control device (42) which interacts with the sensor and the actuator (46) such that the high-pressure seat valve (40) can be activated taking into account the actual value detected by the sensor and the target value specified by the actuator (46).

2. The device (10) according to claim 1, characterized in that the adjustment unit (27) comprises an actuating cylinder (28) or is designed as an actuating cylinder (28), wherein
a piston (30) is slidably mounted in the actuating cylinder (28),
the piston (30) divides the actuating cylinder (28) into a first pressure chamber (32) and a second pressure chamber (34),
the first pressure chamber (32) is connected to the high-pressure line (26) by means of a high-pressure secondary line (36) and a working line (37),
the second pressure chamber (34) is connected to the hydraulic fluid reservoir (18) by means of a second low-pressure line (38), and
the piston (30) is biased against the first pressure chamber (32) with a return spring (39) and/or a counter-piston (78).

3. The device (10) according to any of claim 1, characterized in that
a secondary low-pressure line (50) branches off from the high-pressure secondary line (36) between the high-pressure seat valve (40) and the adjustment unit (27) and opens into the second low-pressure line (38), and
a fixed or variable low-pressure throttle (52) is arranged in the secondary low-pressure line (50).

4. The device (10) according to claim 1, characterized in that
a secondary low-pressure line (50) branches off from the high-pressure secondary line (36) between the high-pressure seat valve (40) and the adjustment unit (27) and opens into the second low-pressure line (38), and
a low-pressure seat valve is arranged in the secondary low-pressure line (50) and can be activated by means of the control device (42) taking into account the actual value detected by the sensor and the target value specified by the actuator (46).

5. The device (10) according to claim 1, characterized in that the high-pressure seat valve (40) is designed as a high-pressure seat valve (56) having an integrated pressure limiting function.

6. The device (10) according to claim 1, characterized in that
the high-pressure secondary line (36) has a bypass line (58) that bypasses the high-pressure seat valve (40), and
a pressure relief valve (60) is arranged in the bypass line (58).

7. A device (10) for controlling a hydraulic pump (12), comprising
a hydraulic fluid reservoir (18),
a hydraulic pump (12) having one inlet (20) and one outlet (22), wherein
the inlet (20) is connected to the hydraulic fluid reservoir (18) by means of a first low-pressure line (24),
the outlet (22) is connected to a high-pressure line (26) to which a consumer (16) can be connected,
an adjustment unit (27) interacting with the hydraulic pump (12) and with which the delivery volume of the hydraulic pump (12) can be changed, the adjustment unit (27) being arranged in a high-pressure secondary line (36) connected to the high-pressure line (26),
a secondary low-pressure line (50) branching off from the high-pressure secondary line (36),
a low-pressure seat valve (54) arranged in the secondary low-pressure line (50) and interacting with the adjustment unit,
a sensor with which an actual value of at least one characteristic variable that can be influenced by the delivery volume of the hydraulic pump (12) and relates to the consumer (16) can be detected,
an actuator (46) with which a target value of the characteristic variable can be specified, and
a control device (42) which interacts with the sensor and the actuator (46) such that the low-pressure seat valve can be activated taking into account the actual value detected by the sensor and the target value specified by the actuator (46).

8. The device (10) according to claim 7, characterized in that the adjustment unit (27) comprises an actuating cylinder (28) or is designed as an actuating cylinder (28), wherein
a piston (30) is slidably mounted in the actuating cylinder (28),
the piston (30) divides the actuating cylinder (28) into a first pressure chamber (32) and a second pressure chamber (34),
the first pressure chamber (32) is connected to the high-pressure line (26) by means of a high-pressure secondary line (36) and a working line (37),
the second pressure chamber (34) is connected to the hydraulic fluid reservoir (18) by means of a second low-pressure line (38), and
the piston (30) is biased against the first pressure chamber (32) with a return spring (39) and/or a counter-piston (78).

9. The device (10) according to claim 7, characterized in that a fixed or variable high-pressure throttle (64) is arranged in the high-pressure secondary line (36).

10. A device (72) for controlling a hydraulic motor (66), comprising
a hydraulic fluid pressure reservoir (74),
a hydraulic motor having one inlet (20) and one outlet (22), wherein
the inlet (20) is connected to the hydraulic fluid pressure reservoir (74) by means of a high-pressure line (26),
the outlet (22) is connected to a hydraulic fluid reservoir (18) by means of a return line (68),
an adjustment unit (27) interacting with the hydraulic motor and with which the displacement volume to be absorbed by the hydraulic motor (66) can be changed,
a high-pressure seat valve (40) arranged in the high-pressure secondary line (36) and interacting with the adjustment unit (27),
a sensor (44) with which an actual value of at least one characteristic variable that can be influenced by the displacement volume to be absorbed by the hydraulic motor (66) can be detected,
an actuator (46) with which a target value of the characteristic variable can be specified, and
a control device (42) which interacts with the sensor and the actuator (46) such that the high-pressure seat valve (40) can be activated taking into account the actual value detected by the sensor and the target value specified by the actuator (46).

11. A device (72) for controlling a hydraulic motor (66), comprising
a hydraulic fluid pressure reservoir (74),
a hydraulic motor having one inlet (20) and one outlet (22), wherein
the inlet (20) is connected to the hydraulic fluid pressure reservoir (74) by means of a high-pressure line (26),
the outlet (22) is connected to a hydraulic fluid reservoir (18) by means of a return line (68),
an adjustment unit (27) interacting with the hydraulic motor and with which the displacement volume to be absorbed by the hydraulic motor (66) can be changed, the adjustment unit (27) being arranged in a high-pressure secondary line (36) connected to the high-pressure line (26),
a low-pressure seat valve (54) arranged in the secondary low-pressure line (50) and interacting with the adjustment unit,
a sensor with which an actual value of at least one characteristic variable that can be influenced by the displacement volume to be absorbed by the hydraulic motor (66) can be detected,
an actuator (46) with which a target value of the characteristic variable can be specified, and
a control device (42) which interacts with the sensor and the actuator (46) such that the low-pressure seat valve (54) can be activated taking into account the actual value detected by the sensor and the target value specified by the actuator (46).

12. The device (10) for controlling a hydraulic pump (12) according to claim 1 or the device (72) for controlling a hydraulic motor (66) characterized in that
the high-pressure seat valve (40) is designed as a high-pressure digital seat valve (41) and/or
the low-pressure seat valve (54) is designed as a low-pressure digital seat valve (55) and/or
the high-pressure seat valve (56) having an integrated pressure limiting function is designed as a high-pressure digital seat valve (57) having an integrated pressure limiting function.

13. The device (10) for controlling a hydraulic pump (12) according to claim 12 or the device (72) for controlling a hydraulic motor (66) according to claim 12,
characterized in that
a pressure present in the working line (37) can be detected by means of a pressure sensor (88) wherein the pressure sensor (88) interacts with the control device (42) such that a high-pressure seat valve (40) and/or a low-pressure seat valve (54) can be activated taking into account the pressure detected by the pressure sensor (88).

14. The device (10) for controlling a hydraulic pump (12) according to claim 13 or the device (72) for controlling a hydraulic motor (66) according to claim 13,
characterized in that
the control device (42) is designed to determine a position of the adjustment unit (27) using the pressure detected by the pressure sensor (88), wherein the high-pressure seat valve (40) and/or the low-pressure seat valve (54) can be activated taking into account the position of the adjustment unit (27) determined by the control device.

15. The device (10) for controlling a hydraulic pump (12) according to claim 14 or the device (72) for controlling a hydraulic motor (66) according to claim 14,
characterized in that
a high-pressure seat valve (40) and/or a low-pressure seat valve (54) can be activated by the control device using an activation variable,
wherein a reference value of the activation variable is stored in the control device (42) depending on the actual value of a characteristic variable that can be influenced by the delivery volume of the hydraulic pump (12) or by the displacement volume to be absorbed by the hydraulic motor (66), and
wherein the control device (42) is designed to detect an actual value of the activation variable corresponding to the actual value of the characteristic variable and to determine a state characteristic value of the hydraulic pump (12) or the hydraulic motor (66) from the comparison of the actual value of the activation variable to a reference value of the activation variable associated with the actual value of the characteristic variable.

16. A method for controlling a hydraulic pump (12) according to claim 13 or a hydraulic motor (66) according to claim 13, wherein a high-pressure seat valve (40) and/or a low-pressure seat valve (54) can be activated using an activation variable, comprising the following steps:
detecting the actual value of at least one characteristic variable that can be influenced by the delivery volume of the hydraulic pump (12) or by the displacement volume to be absorbed by the hydraulic motor (66),
detecting a corresponding actual value of the activation variable,
determining a state characteristic value of the hydraulic pump (12) or hydraulic motor (66) by comparing the actual value of the activation variable to a reference value of the activation variable associated with the actual value of the characteristic variable.

17. The device according to claim 13,
characterized in that
the characteristic variable is determined by the delivery volume or the displacement volume
and/or
the activation variable is determined by the strength of a control current and/or a control duration of the high-pressure seat valve (40) and/or the low-pressure seat valve (54) or their activation frequencies and/or period.
